(19) United States
(12) Patent Application Publication
(10) Pub. No.: US 2024/0310598 A1
(43) Pub. Date: Sep. 19, 2024

(54) THE CAN STAND

(71) Applicant: JOHNNY W. DOLLAR, HOCKLEY, TX (US)

(72) Inventor: JOHNNY W. DOLLAR, HOCKLEY, TX (US)

(21) Appl. No.: 18/604,292

(22) Filed: Mar. 13, 2024

Related U.S. Application Data
(60) Provisional application No. 63/489,875, filed on Mar. 13, 2023.

(51) Int. Cl. G02B 6/46

(52) U.S. Cl. CPC G02B 6/46

(57) ABSTRACT

A can stand assembly includes a base plate, a mount, and a semi-circular support. The assembly is used to support and position an enclosure for fiber optic cables. The enclosure is supported by a post at a distal end of the mount and the semi-circular support. With the enclosure supported and suspended above base plate, a user is able to inspect and work with the associated fiber optic cables therein. A vise assembly is also included to locate and secure objects relative to the mount.

### CROSS REFERENCE TO RELATED APPLICATIONS

This application claims the benefit of an earlier filing date and right of priority to U.S. Provisional Application No. 63/489,875, filed 13 Mar. 2023, the contents of which is incorporated by reference herein in its entirety.

### BACKGROUND OF THE INVENTION

### 1. Field of the Invention

The present application relates to a device used in the installation of fiber-optic cables.

### 2. Description of Related Art

The majority of fiber optics advancements have occurred in the last 50 years. Elias Snitzer of American Optical developed and published a theoretical description of single-mode fibers in 1961. These fibers would be so tiny that they would only be capable of carrying light in a single waveguide mode. TPC-5, the first all-optic fiber cable with optical amplifiers, was built across the Pacific Ocean in 1996. The next year, the Fiber Optic Link Around the Globe (FLAG) network became the world's longest single-cable network, laying the groundwork for the next generation of Internet services. Today, fiber optic technology can be utilized and employed in a multitude of industries, including the medical, military, telecommunications, industrial, data storage, networking, and broadcast industries.

Working with fiber optic cables frequently requires working in restricted spaces, near power lines, and even atop towering poles. These characteristics contribute to a variety of safety dangers, such as dropping a tool on oneself, being exposed to charged wires, high voltages, explosive gases, and other hazards. Those who interact with fiber optic cables as part of their occupation must be aware of any hazards in their workplace and do all possible to avoid exposure to such risks. Because the “fiber” at the center of fiber optic cables is comprised of a strong yet delicate glass, breaking it can result in major injuries and bodily harm to individuals.

Even when fiber optic cables are operational, there will be no visible light coming through the end of the line. However, they can expose you to dangerous infrared radiation, which can cause significant eye damage. People feel these cables are safer than they are since they do not carry an electric charge or function as a heat source, but this is where the true risk lies. Underestimating the obvious risk that exists while working with fiber optic cables is perhaps the biggest error that can be committed. Although an enclosure is utilized to fuse and store individual fibers, the fiber splice container is large and can be labor-intensive for splicing and terminating cables. It is critical for efficiency and accuracy to keep the splicing case stable and secure while splicing and troubleshooting the fiber-optic wires. Current fiber optic enclosures can, inadvertently, contribute to hazardous work conditions and unsafe handling. Although strides have been made, shortcomings remain.

### BRIEF SUMMARY OF THE INVENTION

It is an object of the present application present a can stand assembly that is designed to assist a technician when installing multiple fiber cables when utilizing an enclosure. The assembly secures the enclosure in a particular orientation to ensure a minimum breakage of the fibers. It is an object of the invention that the assembly will increase productivity by making the cable enclosure more accessible and stabilized. A small vise is included for holding the spine while building the case.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a left perspective view of a can stand according to an embodiment of the present application.

FIG. 2 is a right perspective view of the can stand of FIG. 1.

FIG. 3 is an exploded view of the can stand of FIG. 1.

FIG. 4 is an enlarged rear view of the can stand of FIG. 1 with a support member.

FIG. 5 is a left perspective view of the can stand with barrel enclosure.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the can stand assembly is designed to assist a technician when installing multiple fiber cables when utilizing an enclosure. The product secures the enclosure in a particular orientation to ensure a minimum breakage of the fibers. The assembly will increase productivity by making the cable enclosure more accessible and stabilizing the enclosure. A small vise is included for holding the spine while building the case. This device will improve productivity and efficiency for new builds and re-entries. The assembly is durable and constructed of heavy-duty high quality components. The assembly saves time and money while preventing damage and outages. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

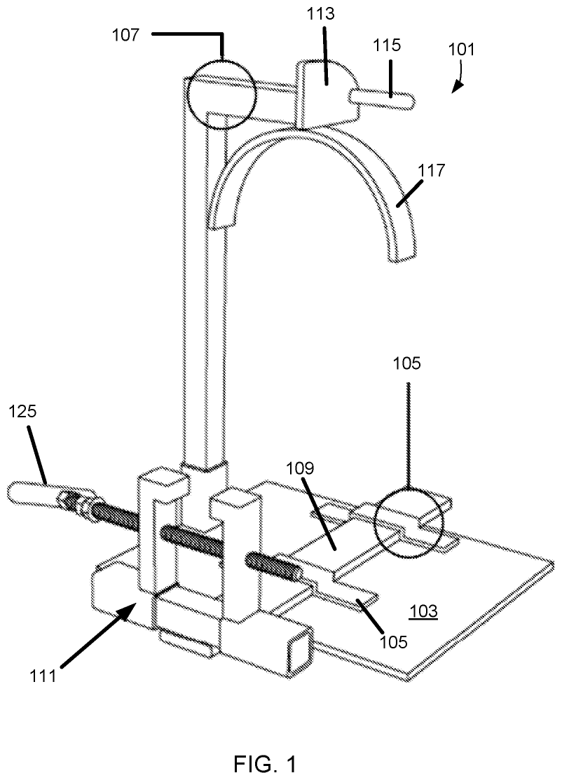

Referring now to FIGS. 1-5 in the drawings, a can stand device/assembly is illustrated. The can stand device 101 is an innovative and original device designed to aid professionals in the installation of fiber-optic cables. Fiber optic cables are often fused and stored within individual enclosures. These cables are spliced through a labor intensive process which terminates within the enclosure. It is imperative that during splicing and troubleshooting of fiber optic wires, the enclosure is stabilized to prevent inadvertent hazardous work conditions and unsafe handling. Device 101 is configured to stabilize and enclosure during such troubleshooting, splicing, and terminating procedures.

Device 101 is configured to include a base plate 103, a mount 107, and a semi-circular support 117. An enclosure is configured to couple along an interior surface of support 117. With the enclosure supported and suspended above base plate 103, a user is able to inspect and work with the associated fiber optic cables therein.

It is understood that the materials used to construct device 101 are strong rigid materials, such as composites, plastic, and even metallic materials. Base plate 103 is configured to provide a support to enhance stability of vertical stand mount 107. The exact size and shape of base plate 103 is not limited to that shown or described herein. It is understood that base plate 103 may be termed to be “heavy duty” such that it's strength is sufficient to support the upright alignment of mount 107.

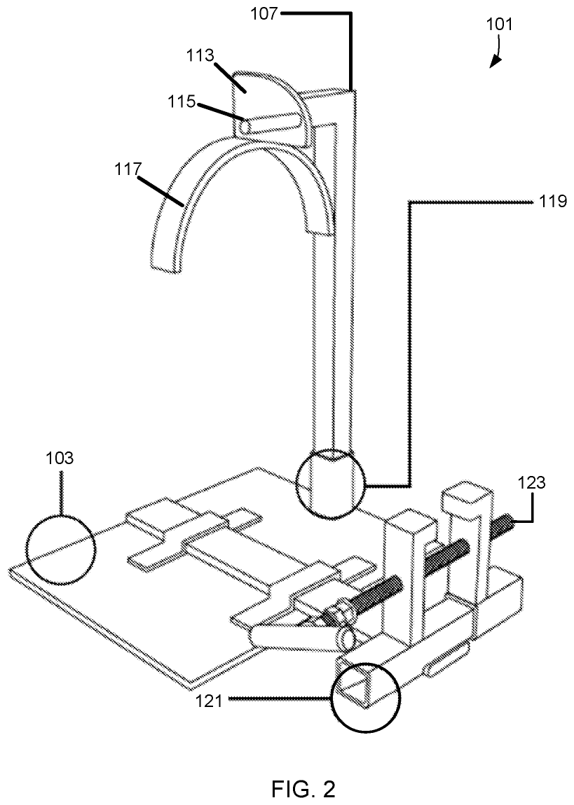

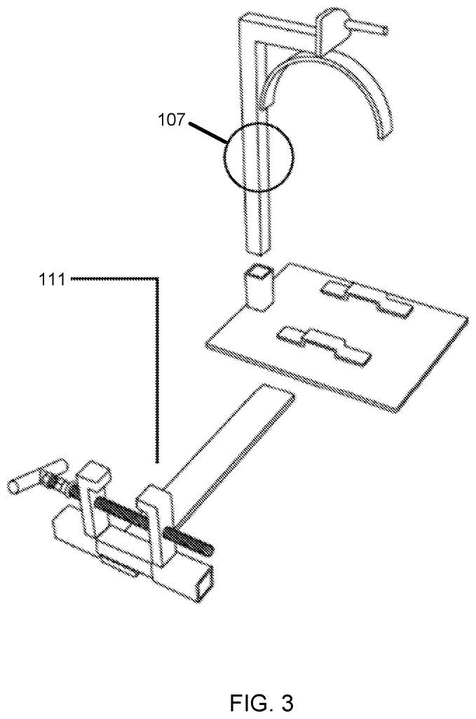

Mount 107 is coupled to an upper surface of base plate 103 and is configured to extend approximately perpendicular therefrom. Mount 107 may include an arm portion that cantilevers away from a vertical member portion, and extends over a portion of base plate 103. The vertical stand mount 107 accommodates a vertical bar that ends at a 90-degree angle at the top. It is understood that mount 107 may be removable from base 103. As seen in FIGS. 2 and 3, vertical stand mount 107 is illustrated in more detail. A mounting socket 119 is secured to plate 103 and is configured to permit mount 107 to be inserted therein or passed around socket 119. One or more fasters may be used to couple socket 119 to the vertical member of mount 107.

A plate 113 Is coupled to a distal end of the arm portion of mount 107. On an opposing surface of plate 113, a horizontal post 115 extends therefrom. The position of post 115 matches a mounting bracket on the barrel enclosure (see FIG. 5). A semi-circular support 117 brace is designed to fit onto the cylindrical end of the barrel enclosure and is located beneath the arm portion. The post 115 has a planar offset from the plane formed by the semi-circular support 117. The enclosure pivots about post 115 and raises an open end of the enclosure against circular support 117. Stand 101 will enable access to the enclosure easier while also keeping it firm and stable.

It is also understood that the dimensions and sizing of mount 107 may be different amongst different embodiments. Therefore a user may be able to swap mounts depending on conditions such as the size of the enclosure, the number of fiber optic cables, expected weight, or even possibly the orientation or particular environment around the cables, to name a few.

Referring in particular to FIG. 3 in the drawings, a vise assembly is illustrated. Vise assembly 111 is a fully adjustable vise made up of two end pieces 121 where in one end piece is configured to translate over and around the other. Each of the two end pieces 121 include a vertical jaw that is threadedly coupled together via a threaded screw post 123. Rotation of post 123 acts to adjust the distance between the vertical jaws and or result in the translation of the two end pieces 121 relative to each other. Vice assembly 111 is configured to clasp or securely hold one or more elements relative to mount 107 and or and then closure. Vice assembly 111 may be used on all sizes and types of enclosures with a single device.

Device 101 may further include two brackets 105 configured to operated with vise assembly 111. Brackets 105 are couple 2IN upper surface a base plate 103 and are formed so as to include an elevated central portion. Vise assembly 111 includes a bar 109 coupled at least one of end pieces 121 and is configured to glide or translate within the elevated central portion of brackets 105. Not only can the jaws of end pieces 121 translate along one axis, but the vice may also translate along a separate second axis along the length of bar 109. Vise assembly 111 includes a crossbar handle 125 that is permanently attached. The handle and threaded post may be adjusted to tighten or loosen the vise depending on how far the handle is rotated.

In operation, vise assembly 111 is coupled to bar 109 and is oriented so as to be elevated above plate 103. Operation of the threaded post 123 selectively translates both ends of a clamp so as to narrow the distance or increase the distance. As seen in FIG. 3, vise assembly 111 may be rigidly coupled to bar 109. The location of vise assembly 111 relative to plate 103 is adjustable by translating bar 109 through brackets 105. Additionally, vise assembly 111 may be located extending from either side of plate 103.

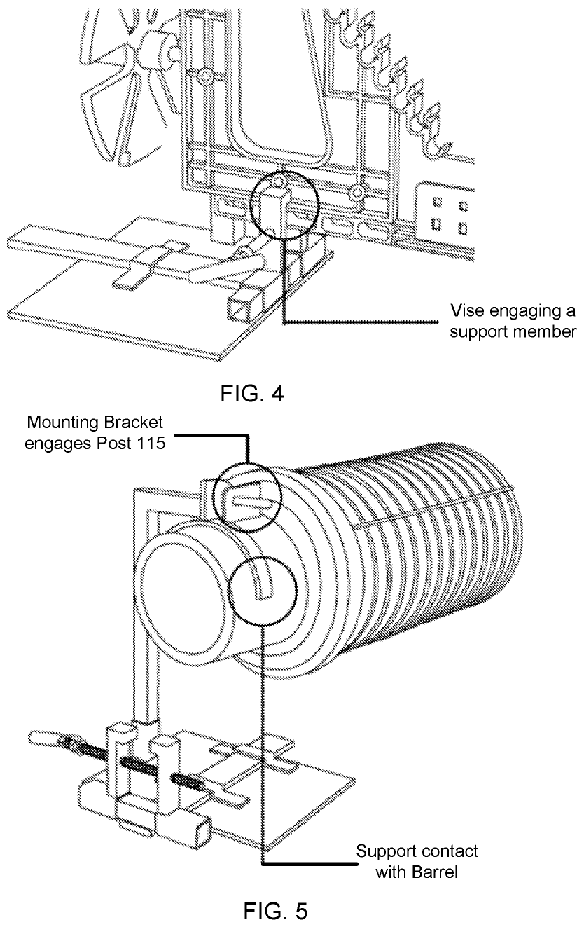

Referring now also to FIGS. 4 and 5 in the drawings, additional views of stand 101 are provided. Vise assembly 111 is shown in use with housing support members that are designed to be different sizes. Vise assembly 111 is configured to adjust to the size of these members and be able to accurately locate them relative to support 117. In FIG. 5 a barrel enclosure is shown engaged with support 117. Fiber-optic enclosures are secured to stand 101. Post 115 is coupled to the vertical support assembly and couples to the bracket on the barrel. An end of the barrel is then automatically rotated so as to contact the support 117. The weight of the barrel keeps contact with the end and the support 117.

Assembly 101 is intended to be both practical and functional. The marketability is enhanced by the relative simplicity of manufacturing and reasonably priced components. Increased safety and productivity benefit the user, which should generate significant market interest in the product. Any materials may be used in construction of the various components. One or more coatings may be used as well.

Assembly 101 is configured to allow simpler access and maintain the building enclosures sturdy and stable position without the additional strain. This is done by stabilizing the building enclosures and reducing the additional requirement and physical strain to do so manually. When installing and splicing fiber optic cables, stand 101 will boost productivity while decreasing breakage and outages, letting an operator's concentration remain on the operation at hand. Stand 101 also decreases installation time by allowing operators to spend less time maneuvering small places or distracted with the placement of the enclosure and cables and more time on the work at hand.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A stand assembly for fiber optic cables, comprising:
a base plate;
a mount coupled to the base plate and configured to extend above an upper surface of the base plate;
a post extending away from the mount;
a semi-circular support coupled to a distal end of the mount below the post; and
a vise assembly coupled to the base plate and being below the semi-circular support.

2. The assembly of claim 1, wherein the mount is removable from the base plate.

3. The assembly of claim 1, wherein the vise assembly is configured to translate along the upper surface of the base plate.

4. The assembly of claim 1, wherein the base plate includes a plurality of brackets having an elevated central portion.

5. The assembly of claim 4, wherein the vise assembly includes a bar configured to translate between the elevated central portion and the upper surface of the base plate.

6. The assembly of claim 1, wherein a position of the vise assembly relative to the mount is adjustable.

7. The assembly of claim 1, wherein the post has a planar off set from semi-circular support.

8. The assembly of claim 1, further comprising:
a surface plate configured to locate the post and semi-circular support on a distal end of the mount.

9. The assembly of claim 1, wherein the post and the semi-circular support are coupled to the mount at different locations.

10. A method of attaching an enclosure to a stand assembly, comprising:
obtaining a stand assembly in claim 1;
rotating the enclosure relative to the base plate;
inserting the post through an aperture in a bracket on the enclosure;
rotating the enclosure about the post such that an opening of the enclosure raises into contact with a lower surface of the semi-circular support; and
adjusting the vise assembly.

11. The method of claim 10, wherein the vise assembly is adjusted by translating it relative to the base plate.

12. The method of claim 10, wherein the vise assembly is adjusted by opening and closing the vise assembly.

13. The method of claim 10, further comprising:
removing the mount from the base plate.
